(19) United States
(12) Patent Application Publication
(10) Pub. No.: US 2018/0265044 A1
(43) Pub. Date: Sep. 20, 2018

(54) DEVICE FOR CONNECTING A WINDSCREEN WIPER BLADE TO A DRIVE ARM

(71) Applicant: Valeo Systèmes d'Essuyage, Le Mesnil Saint Denis (FR)

(72) Inventors: Vincent Gaucher, Issoire (FR); Stéphane Houssat, Issoire (FR); Guillaume Mouleyre, Issoire (FR)

(73) Assignee: Valeo Systèmes d'Essuyage, Le Mesnil Saint Denis (FR)

(21) Appl. No.: 15/922,169

(22) Filed: Mar. 15, 2018

(30) Foreign Application Priority Data
Mar. 17, 2017 (FR) 1752194

(51) Int. Cl. B60S 1/38; B60S 1/40

(52) U.S. Cl. CPC B60S 1/3853; B60S 2001/4035; B60S 1/4006

(57) ABSTRACT

Device (60) for connecting a windscreen wiper blade to a drive arm, comprising:
a connector (24) that is designed to be rigidly connected to said blade and that includes first articulation means (38),
an adapter (12) that is designed to be rigidly connected to said arm and that includes second articulation means (42) that are designed to cooperate with said first articulation means in order to form a first pivot axis (Y) between the adapter and the connector, which is a pivot axis between said blade and said arm, and
a cover (62) that is designed to be attached to the connector, said cover being moveable from a first position in which the cover enables said adapter to be connected to said arm, and a second position in which the cover locks said connection.

### TECHNICAL DOMAIN

The present invention notably relates to a device for connecting a windscreen wiper blade to a drive arm, in particular on a motor vehicle.

### PRIOR ART

A motor car is conventionally fitted with windscreen wipers to wash the windscreen and to ensure that the driver's view of the surrounding environment is not disturbed. These windscreen wipers usually comprise a drive arm performing an angular to-and-fro movement, and elongated blades carrying rubbers made of an elastic material. These rubbers rub against the windscreen and move the water out of the driver's field of vision. In a conventional version, these blades are articulated yokes that hold the rubber at several different points, enabling same to bend to fit the curve of the windscreen. In a more recent version, referred to as “flat blade”, the blades comprise a semi-rigid assembly that holds the rubber along the entire length of same using one or more curving links enabling the blade to be applied to the windscreen without having to use yokes.

In both solutions, the blade is attached to the drive arm by a connection device (“arm/blade connection device) including an adapter and a connector). The connector is a part that is rigidly connected to the blade and that can be built into the blade. The connector is attached directly to the rubber or to the flat blade, while the adapter is rigidly connected to the arm. The adapter is an intermediate part that enables the linking and attachment of the connector to the drive arm. The adapter is designed to cooperate with a head or end part of the drive arm.

The connector and the adapter each have articulation means designed to cooperate with complementary means on the other member in order to form at least one transverse pivot axis between the connector and the adapter, which is a pivot axis between the blade and the arm. In the prior art, one of the members, such as the connector, usually includes a substantially cylindrical physical shaft that forms the pivot axis and that is received in a seat of matching shape in the other member.

In some cases, the adapter is mounted in a seat of the connector or of the blade and has two substantially parallel walls that are separated from one another and linked together by at least one linking element. The walls of the adapter have inner lateral faces between which this linking element lies, and outer lateral faces that are designed to be positioned to face the inner lateral faces of the seat of the connector or of the arm, and to cooperate slidingly with these faces when the adapter pivots in relation to the connector or the blade.

The adapter can also have a stop element that is carried on one of the side walls thereof and that projects at least partially beyond the outer lateral face of said wall. Patent FR2902394 discloses such a stop element. When the adapter is mounted in the seat of the connector, the adapter can turn about the aforementioned pivot axis. The stop element of the adapter is designed to cooperate with the connector to limit the travel of the adapter about this axis to a given angular range. This enables the adapter to remain in a position that facilitates the assembly of the adapter on the drive arm. The cooperation between the stop element and the connector is therefore only sought to help the user to assemble the adapter and therefore the blade in general. The stop element is not usually used during operation of the blade.

It is also known to fit an arm/blade connection device with a cover, for example to improve the aesthetic appearance of the device. Such a cover can also be used to lock the arm/blade connection, thereby ensuring this connection when wiping a glass. The cover is usually moveable from a first position in which the cover enables the adapter to be connected to the arm, and a second position in which the cover locks the arm\blade connection and prevents any unintended disconnection of the arm from the blade, in particular when in use.

The invention proposes an improvement on this technology.

### DESCRIPTION OF THE INVENTION

For this purpose, the invention proposes a device for connecting a windscreen wiper blade to a drive arm, comprising:

a connector that is designed to be rigidly connected to said blade and that includes first articulation means,

an adapter that is designed to be rigidly connected to said arm and that includes second articulation means that are designed to cooperate with said first articulation means in order to form a first pivot axis between the adapter and the connector, which is a pivot axis between said blade and said arm, and

a cover that is designed to be attached to the connector, said cover being moveable from a first position in which the cover enables said adapter to be connected to said arm, and a second position in which the cover locks said connection, said cover is designed to enable said adapter to move about said first axis when the cover is in the locked position, and said adapter is designed to adopt:

at least one release position in which said cover can be moved between the first and second positions thereof, and

at least one locked position in which said adapter is able to butt against said cover to limit the travel of the cover from the second position thereof, thereby preventing the cover from reaching the first position thereof.

Consequently, the cover cannot reach the position in which the arm can be attached to or detached from the adapter if the adapter is in the locked position. The locked position of the adapter therefore results in the locking of the arm/blade connection, providing an additional guarantee in this regard. As set out above, the first assurance is provided by the cover itself. However, if the cover is damaged or incorrectly positioned, the invention secures the arm/blade connection, therefore providing redundant locking of the arm/blade connection.

The device according to the invention may include one or more of the characteristics below, taken individually or in combination with one another:

said adapter has two walls that are substantially parallel with one another and perpendicular to said first axis, said walls having first inner lateral faces between which at least one linking element lies, and outer lateral faces, said adapter also having at least one stop element that is carried on one of said walls thereof and that projects at least partially beyond said outer lateral face of said wall, said at least one stop element being designed, when said adapter is in said at least one locked position, to butt against said cover to limit the travel thereof from the second position thereof, thereby preventing the cover from reaching the first position thereof,

said element is formed as a single part with said wall,

said cover has two walls that are substantially parallel with one another and perpendicular to said first axis, said cover also having at least one slot that is arranged on one of said walls and that is designed to enable said adapter to pass through said stop element of said adapter when said cover is in the second position thereof,

said slot is obtained by a local reduction in the thickness of said wall or of a flange of said wall,

said walls have first inner lateral faces that are substantially opposite one another and outer lateral faces, said slot being formed at least partially in the inner lateral face of said wall,

said cover is mounted pivotingly on said connector and is pivotingly moveable about a second axis between said first and second positions,

said first and second axes are substantially parallel,

said cover is designed to at least partially overlap said adapter and/or said connector,

said cover has an opening that is designed to be traversed by a portion of said arm.

The present invention also relates to a windscreen wiper blade, the windscreen wiper blade having or carrying a device such as the one described above.

The present invention also relates to a windscreen wiper arm, the windscreen wiper arm having or carrying a device such as the one described above.

The arm is for example a hook arm that is mounted between the side walls of the adapter.

### DESCRIPTION OF THE FIGURES

The invention can be better understood from, and other details, features and advantages of the invention are set out in, the description below, given by way of non-limiting example and with reference to the attached drawings, in which:

FIG. 1 is an exploded schematic perspective view of a windscreen wiper blade, this windscreen wiper blade being fitted with a connection device to a drive arm (partially shown),

FIG. 2 is a schematic perspective view on a larger scale of the connection device in FIG. 1, including a connector and an adapter mounted in this case on one end of the drive arm,

FIG. 3 is another schematic perspective view of the adapter in FIG. 2,

FIG. 4 is an exploded schematic perspective view of a connection device according to the invention,

FIGS. 5 to 7 are schematic perspective views of a cover of the connection device in FIG. 4,

FIG. 8 is a schematic perspective view of the device in FIG. 4, showing a first position of the cover thereof,

FIGS. 9 and 10 are schematic perspective views of the device in FIG. 4, showing a second position of the cover thereof,

FIG. 11 is a schematic perspective view of the device in FIG. 4, showing the adapter in a release position, and

FIG. 12 is a schematic perspective view of the device in FIG. 4, showing the adapter in a locked position.

### DETAILED DESCRIPTION

It should be noted that the figures show the invention in detail to enable the invention to be carried out, and these figures may be understood to better define the invention where appropriate.

In the description below, the terms longitudinal and lateral relate to the orientation of the windscreen wiper blade or of the drive arm. The longitudinal direction corresponds to the main axis of the blade or of the arm along which same extends, while the lateral orientations correspond to convergent straight lines, i.e. lines crossing the longitudinal direction, notably perpendicular to the longitudinal axis of the blade or of the arm in the plane of rotation of same. For the longitudinal directions, the terms outer (or rear) or inner (or front) shall be understood in relation to the point of attachment of the blade to the arm, the term inner corresponding to the portion where the arm and a half-blade extend, or in relation to the point of attachment of the arm to the vehicle. Finally, the directions referred to as upper and lower correspond to orientations perpendicular to the plane of rotation of the windscreen wiper blade, the term lower containing the plane of the windscreen.

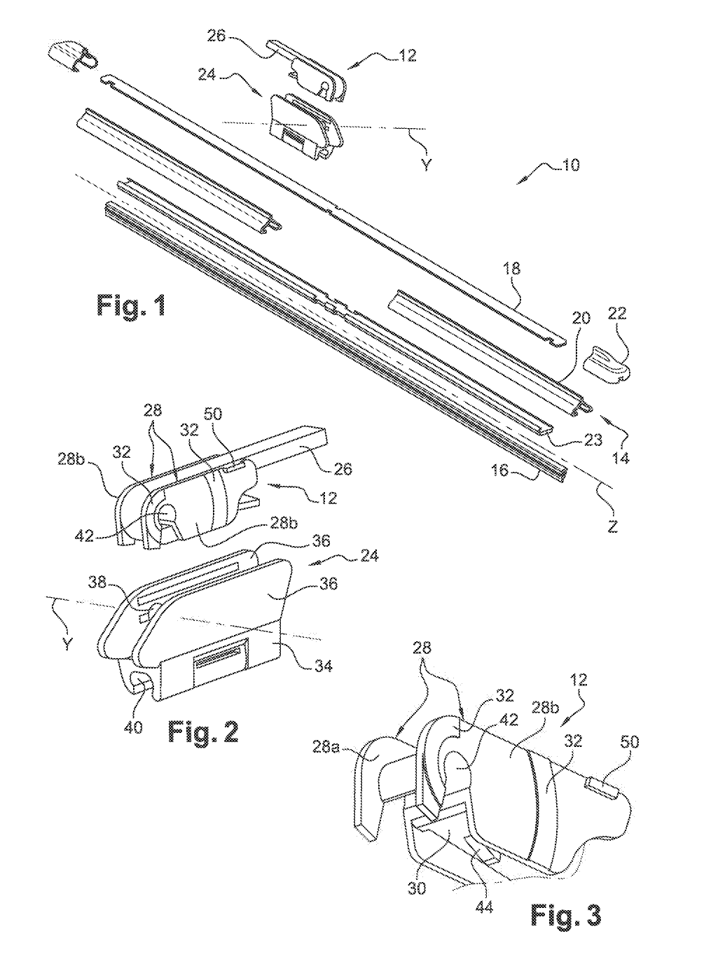

FIG. 1 shows a windscreen wiper blade 10 fitted with a connection device including an adapter 12 and a connector 24.

In the example shown, the blade 10 is a flat blade and includes a longitudinal body 14, a wiper rubber 18, which is usually made of rubber, and at least one link 18 that stiffens the rubber and facilitate the application of same to a glass such as a windscreen of the vehicle.

The body 14 of the blade 10 may include an upper aerodynamic deflector 20 designed to improve operation of the wiping system, this deflector being intended to better press the blade against the windscreen, thereby improving the aerodynamic performance of the windscreen wiper.

The blade 10 may also include end caps 22 or clips for fastening the rubber 16 and the link 18 to the body 14, each of these caps 22 being located at the longitudinal ends of the body 14.

The blade 10 also has an attachment element 23 for the rubber 16 that is seated in the body 14.

The connector 24 is designed to receive the adapter 12 and is positioned substantially in the middle of the blade 10, the connector/adapter assembly forming the device for connecting the blade 10 to the drive arm 26. The arm 26 is in this case shown only partially, only the free connection end to the adapter 12 being visible.

The adapter 12 is mounted on the connector 24 in order to maintain a degree of freedom in rotation about a pivot axis Y that is a transverse axis substantially perpendicular to the longitudinal axis Z of the blade 10. This degree of freedom enables the blade 10 to pivot in relation to the arm 26, thus enabling the blade to follow the curve of the windscreen when moving.

The arm 26, shown more dearly in FIG. 2, is designed to be driven by a motor to follow an angular to-and-fro movement in order to remove water and any other unwanted elements covering the windscreen. The free connection end to the adapter 12 forms a U-shaped hook, creating an opening designed to receive the adapter 12.

The adapter 12 has two parallel side walls 28 that are separated from one another and linked together by at least one transverse wall 30 (FIG. 3). The walls 28 have inner lateral faces 28a between which the transverse wall 30 lies, and outer lateral faces 28b including projecting patterns 32.

The connector 24, shown more clearly in FIG. 2, includes a substantially parallelepipedic base 34 surmounted by two side walls 36 that extend the lateral faces of the base upwards and that are designed to clamp the side walls 28 of the adapter once the adapter has been snap-fitted into the connector 24.

The gap between the walls 36 and the connector 24 is therefore slightly greater than the gap between the outer lateral faces 28b of the adapter. A transverse shaft 38 extends between the two walls 36, defining the axis Y about which the adapter 12 is designed to turn with predefined angular limits. Finally, the lower portion of the base 34 has a slot 40 for assembling the rest of the blade 10, and in particular the attachment element 23.

FIG. 3 shows other details of the adapter 12, in particular the transverse wall 30 thereof. The wall 30 is extended longitudinally from the outer end thereof by a semi-cylindrical bearing trough 42 designed to receive the transverse shaft 38 of the connector when same is snap-fitted onto the adapter. To ensure this snap-fitting, the opening of the trough 42 is slightly less than 180° such that a force needs to be exerted to insert the shaft 38 into the trough 42.

FIG. 3 also shows a lug 44 positioned on the transverse wall 30 that enables, in cooperation with an orifice (not shown) made in the U-shaped free end of the arm 26 to rigidly connect the latter to the adapter 12.

The adapter 12 can be assembled as follows: The adapter is inserted between the walls 36 of the connector 24 until the shaft 38 snap-fits into the trough 42 of the adapter, then the arm 26 engages with the adapter such that the free end thereof blocks the opening of the trough 42 (FIG. 2) and prevents the adapter from becoming detached from the connector.

The projecting patterns 32 of the outer faces 28b of the adapter 12 are designed to cooperate slidingly with the inner faces facing the walls 36 of the connector, notably in order to guide the pivoting movement about the axis Y of the blade 10 in relation to the arm 26 when in use.

The adapter 12 also includes a stop element 50 shown in FIGS. 2 and 3. This stop element 50 is positioned on one of the side walls 28 of the adapter and projects from the outer face 28b of said wall. The stop element has an overall parallelepiped shape and the thickness or transverse dimension thereof, measured in a direction parallel to the axis Y, is greater than the thickness of the patterns 32.

When the adapter 12 is assembled and snap-fitted in the connector 24, the stop element 50 is designed to butt against the upper longitudinal edge of one of the side walls 36 of the connector 24, in order to limit the angular movement of the adapter about the axis Y in relation to the connector, in at least one direction (for example clockwise).

The projecting element 50 is attached to and forms a single part with the adapter 12.

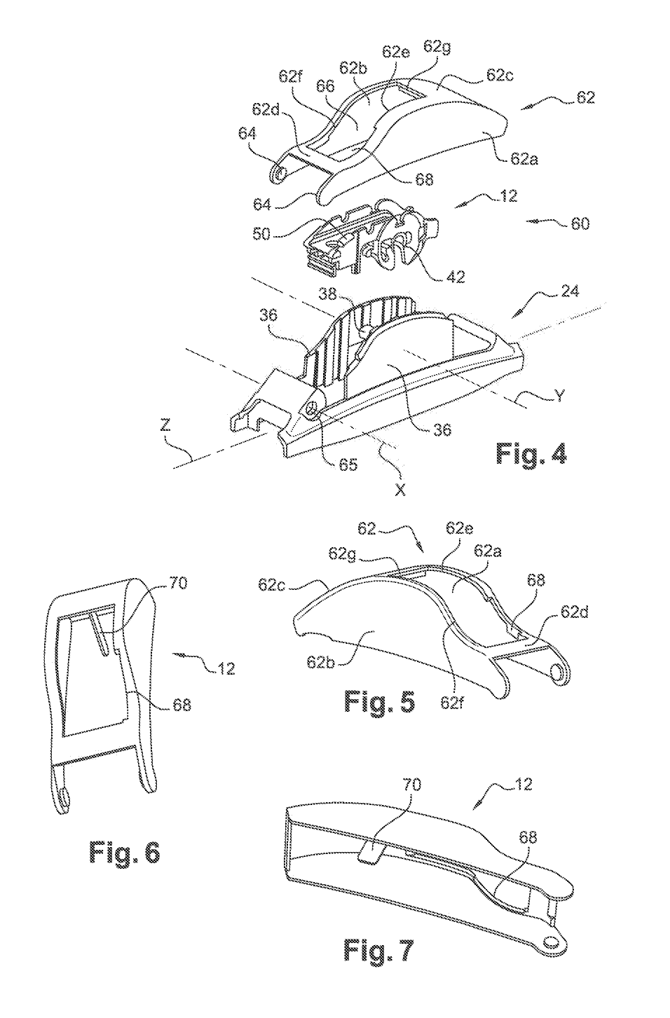

FIG. 4 et seq. show an embodiment of a connection device 60 according to the invention that includes a cover 62 in addition to an adapter 12 and a connector 24.

The adapter 12 and the connector 24 in FIG. 4 et seq. can be considered to include all of the characteristics of the adapter 12 and of the connector 24 in FIGS. 1 to 3. The same reference signs are therefore used to identify these parts and the different portions thereof.

In the example embodiment shown, the cover 62 is mounted on the connector 24. The cover is articulated with the connector 24 about an axis X substantially perpendicular to the axis Y.

The cover 62 has a general elongate shape along the longitudinal axis Z of the blade and includes articulation means about the axis X at one of the longitudinal ends thereof.

More specifically, the cover 62 in this case has two side walls 62a, 62b that are substantially flat and parallel with one another and with the longitudinal axis Z. The side walls are separated from one another and linked together by upper walls 62c, 62d.

A first upper wall 62c, referred to as the outer upper wall, extends between the upper edges of the walls 62a, 62b and from the outer longitudinal end of the cover over a length that is for example approximately 30-50% of the total length of the cover.

A second upper wall 62d, referred to as the inner upper wall, extends between the upper edges of the walls 62a, 62b close to the inner longitudinal end of the cover. In this case, the upper wall is short, being for example no more than 10% of the total length of the cover.

The inner faces of the inner longitudinal end of the cover 62 facing the side walls 62a, 62b have two projecting cylindrical contacts 64 respectively. The contacts 64 are coaxial and define the pivot axis X of the cover. The contacts are designed to cooperate by elastic snap-fitting with the matching recesses 65 of the connector 24 during assembly of the cover on the connector, and by sliding when the cover is pivoting in relation to the connector.

The upper walls 62c, 62d together define an opening 66 of the cover that is designed to be traversed by the arm when linking to the adapter 12, and in the usage position of the windscreen wiper blade.

At this opening 66, the upper edges of the side walls 62a, 62b have opposing peripheral flanges 62e, 62f. Thus, the upper edge of the wall 62a has a flange 62e that is oriented inside the opening 66 towards the wall 62b. The upper edge of the wall 62b has a flange 62f that is oriented inside the opening 66 towards the wall 62a.

On account of the shape or profile of the upper edges of the walls 62a, 62b, each flange 62e, 62f in this case has a general S shape. Each flange has a double curve. Each flange 62e, 62f has an upwards-oriented concave curvature near to the inner end of the cover, and an upwards-oriented convex curvature near to the outer end of the cover.

The dimension measured along the axis X or thickness of the flange 62f of the wall 62b is constant along the entire length thereof (i.e. along the entirety of the flange along the axis Z). Conversely, the dimension measured along the axis X or thickness of the flange 62e of the wall 62a varies along the length thereof. The thickness of the flange 62e at the upwards-oriented convexity thereof is constant and substantially the same as the thickness of the flange 62f. The thickness of the flange 62e at the upwards-oriented concave curvature thereof is less than the rest of the flange 62e and less than the thickness of the flange 62f. The reduced thickness of the flange 62e forms a through-slot 68 for the stop element 50 of the adapter 12.

The cover 62 is positioned on the connector 24 and overlaps same at least partially. The cover 62 can also overlap a portion of the adapter. The cover 62 is in this case designed to overlap the side walls 36 of the connector, the inner lateral faces of the side walls 62a, 62b of the cover being designed to face the side walls 36 of the connector. The gap between the walls 62a, 62b of the cover 62 is therefore slightly greater than the gap between the outer lateral faces of the side walk 36 of the connector 24. The shape of the side walls 36 can be similar to the shape of the walls 62a, 62b. In particular, the upper edges of the walls 36 can be S-shaped, similar to the shape of the upper edges of the walls 62a, 62b and the flanges 62e, 62f thereof.

The cover 62 also has a projecting lug 70 on a lower face of the upper wall 62c thereof that is designed to butt against the free end of the arm in a direction parallel to the axis Z when said arm is linked to the adapter 12, in order to lock the arm/blade connection (FIGS. 6 and 7).

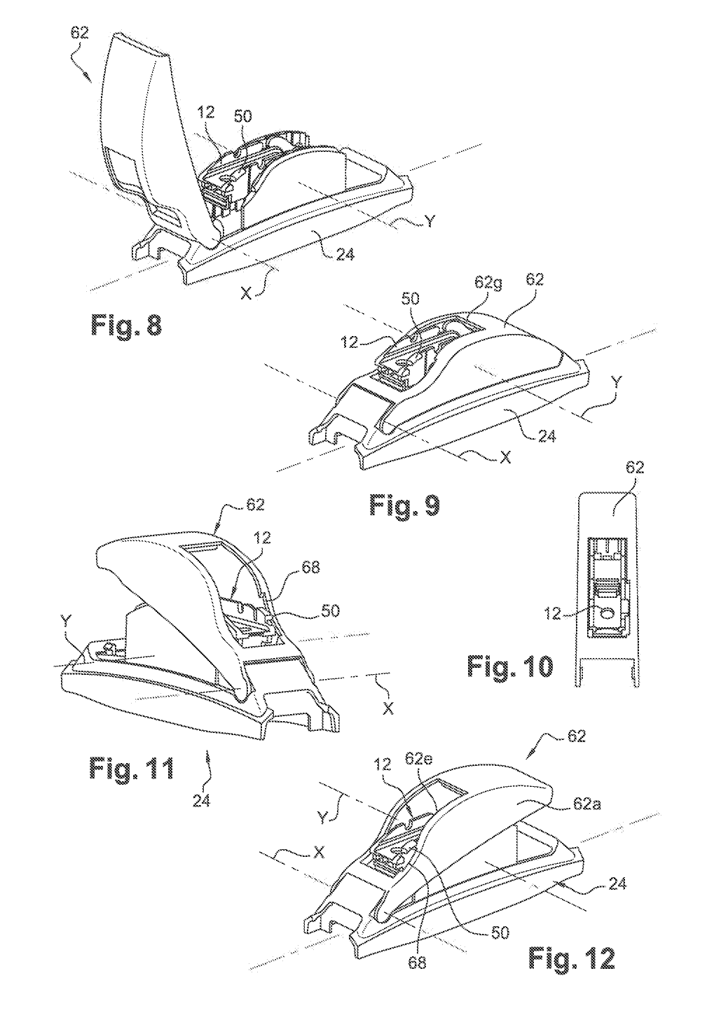

The cover 62 is moveable about the axis X from a position shown in FIG. 8 in which the cover enables the arm to be connected to the adapter 12, which is in effect freely accessible, to a closed position shown in FIGS. 9 and 10 in which the cover lock the arm/blade connection. In the latter position, the arm (not shown) passes through the opening 66 in the cover and extends substantially parallel to the axis Z. The arm can butt axially against the lug 70 of the cover, which prevents the arm from becoming accidentally detached from the blade.

The arm/blade connection can be carried out as follows: The blade is moved along the axis Z towards the arm such that the free end of the latter passes through the opening 66 in the cover, when the cover is in the position in FIG. 8. The free end of the arm is then mounted on the adapter 12, which can be pivoted about the axis Y to facilitate this assembly. The cover 62 is then closed, i.e. in the position shown in FIGS. 9 and 10.

The cover 62 can adopt a multitude of intermediate positions between the aforementioned end positions shown in FIGS. 8 to 10.

The adapter 12 is moveable about the axis Y from a stop position in which the stop element 50 bears against the upper edge of the wall 36 of the connector, for example at the concave curvature thereof, to a position in which same bears against the transverse edge 62g of the upper wall 62c of the cover 62. This is the case when the cover 62 is in the closed position (FIGS. 9 and 10). When the cover 62 is in the open position (FIG. 8), the adapter 12 can be moved from the stop position to another stop position in which the stop element 50 thereof bears against the upper edge of the wall 36 of the connector, for example at the upper convexity thereof.

The adapter 12 can adopt a multitude of intermediate positions between these end positions.

Of these intermediate positions, the adapter 12 can adopt at least one position shown in FIG. 11 in which, when the cover 62 is moved about the axis X, the adapter can be moved easily between the end positions thereof shown in FIGS. 8 to 10. During such movements, the stop element 50 passes through the aforementioned slot 68 in the cover.

Of these intermediate positions, the adapter 12 can also adopt at least one position shown in FIG. 12 in which, when the cover 62 is moved about the axis X from the closed position, the adapter moves over a shorter path since the upper edge of the wall 62a or the thicker flange 62e of said wall 62a butts against the stop element 50.

In practice, assuming for example that the adapter 12 is moveable about the axis Y through approximately 120°, if the cover is in the closed position shown in FIGS. 9 and 10:
all of the positions of the adapter between the stop position of the element 50 on the connector 24, and a position referred to as the transition position, are such that the cover is free to move between the end positions thereof, and
all of the positions of the adapter between the stop position of the element 50 on the cover 62, and the position referred to as the transition position, are such that the cover is not free to move as far as the fully open position shown in FIG. 8.

The transition position is for example an angle of 30-40° measured from the stop position on the connector 24.

Advantageously, once the cover 62 is closed and the blade is placed on the windscreen, the steeving pivots the adapter 12 and therefore the stop element 50 thereof. The latter is no longer facing the slot 68, which locks the cover 62 in the event of opening in this usage phase.

1. The device for connecting a windscreen wiper blade to a drive arm, comprising:
a connector that is designed to be rigidly connected to said blade and that includes first articulation means;
an adapter that is designed to be rigidly connected to said arm and that includes second articulation means configured to cooperate with said first articulation means to form a first pivot axis between the adapter and the connector, the first pivot axis being between said blade and said arm; and
a cover configured to be attached to the connector, said cover being moveable from a first position in which the cover enables said adapter to be connected to said arm, and a second position in which the cover locks said connection,
wherein said cover enables said adapter to move about said first axis when the cover is in the locked position, and
said adapter is configured to adopt:
at least one release position in which said cover can be moved between the first and second positions thereof, and
at least one locked position in which said adapter is able to butt against said cover to limit the travel of the cover from the second position thereof, thereby preventing the cover from reaching the first position thereof.

2. The device according to claim 1, wherein said adapter has two walls that are substantially parallel with one another and perpendicular to said first axis, said walls having first inner lateral faces between which at least one linking element lies, and outer lateral faces, said adapter also having at least one stop element that is carried on one of said walls thereof and that projects at least partially beyond said outer lateral face of said wall, said at least one stop element being designed, when said adapter is in said at least one locked position, to butt against said cover to limit the travel thereof from the second position thereof, thereby preventing the cover from reaching the first position thereof.

3. The device according to claim 1, wherein said element is formed as a single part with said wall.

4. The device according to claim 2, wherein said cover has two walls that are substantially parallel with one another and perpendicular to said first axis, said cover also having at least one slot that is arranged on one of said walls and that enables said adapter to pass through said stop element when said cover is in the second position thereof.

5. The device according to claim 4, wherein said slot is obtained by a local reduction in the thickness of said wall or of a flange of said wall.

6. The device according to claim 4, wherein said walls have first inner lateral faces that are substantially opposite one another and outer lateral faces, said slot being formed at least partially in the inner lateral face of said wall.

7. The device according to claim 1, wherein said cover is mounted pivotingly on said connector and is pivotingly moveable about a second axis between said first and second positions.

8. The device according to claim 7, wherein said first and second axes are substantially parallel.

9. The device according to claim 1, wherein said cover at least partially overlaps said adapter and/or said connector.

10. The device according to claim 1, wherein said cover has an opening that is traversed by a portion of said arm.

11. A windscreen wiper blade comprising or carrying a device according to claim 1.

12. An arm of a windscreen wiper blade, comprising or carrying a device according to claim 1.
